(19) United States
(12) Patent Application Publication
(10) Pub. No.: US 2023/0173839 A1
(43) Pub. Date: Jun. 8, 2023

(54) Floral Preservation/Display Kit and Method of Use

(71) Applicants: Natalie N. LaRosa, Pittsburgh, PA (US); Rocky Medure, Pittsburgh, PA (US)

(72) Inventors: Natalie N. LaRosa, Pittsburgh, PA (US); Rocky Medure, Pittsburgh, PA (US)

(21) Appl. No.: 17/545,922

(22) Filed: Dec. 8, 2021

Related U.S. Application Data
(60) Provisional application No. 63/122,657, filed on Dec. 8, 2020.

(51) Int. Cl. B44C 5/06; A01G 5/06

(52) U.S. Cl. CPC B44C 5/06; A01G 5/06

(57) ABSTRACT

A kit for taking cut flowers and preserving them into a three-dimensional display comprises, in one box: a pre-packaged amount of silica (or other drying) gel; one or more packets of pre-measured epoxy resin; mixing tools and bubble popper; at least one end product mold, and a directions/instruction card. A method of use is also disclosed.

### REFERENCE TO RELATED APPLICATIONS

This application is a perfection of U.S. Provisional Application No. 63/122,657, filed on Dec. 8, 2020, the disclosure of which is fully incorporated by reference herein.

### STATEMENT OF GOVERNMENT INTEREST

Not Applicable

### STATEMENT AS TO RIGHTS TO INVENTIONS MADE UNDER FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### (1) Field of the Invention

The present invention relates to a method for preserving cut flowers especially flowers from a sentimental arrangement like an engagement or wedding bouquet, or possibly flowers from a funeral. While the inventors currently offer their company's services in preparing customer keepsakes through their website: www.soilandsoul.studio, it is anticipated that do-it-yourselfers may desire to follow the inventors' directions (i.e., method steps) and using the inventors' display kit with its various components and one or more end product molds to preserve their own live flower arrangements.

### (2) Description of Related Art

For matters relating to the preservation of cut flowers, in general, consider the following: U.S. Pat. Nos. 4,312,134, 5,834,074, and 9,006,140, Published U.S. Application Nos. 20040186020, 20090084032 and 20180295784, JP Nos. 2000119102, 2007119459 and 2009099008, AU No. 2004208441, RU No. 2185051, KR Nos. 20080020034 and 20190142945, CN Nos. 103918645, 106163275 and 106212445, and WO2004066727.

### BRIEF SUMMARY OF THE INVENTION

The kit for taking cut flowers and preserving them into a three-dimensional display comprises, in one box: a pre-packaged amount of silica (or other drying) gel; one or more packets of pre-measured epoxy resin formulae; tools including a mixing stick, mixing cup and “optional” timer; one or more end product molds, including those for making a ring holder, a paperweight and still other optional end products and a directions/instruction card.

The method for making preserved flower display products with the aforementioned kit includes: (1) a selecting and cutting step; (2) a drying step; (3) a mold arranging step; and (4) a resin adding step. After curing, the desired end product is removed from the mold and polished, as needed, using a polishing cloth included with the kit.

### BRIEF DESCRIPTION OF THE DRAWING(S) AND PHOTOGRAPHS

Further features, objectives and advantages will become clearer when reviewing the following description of preferred embodiments made with reference to the accompanying drawings and photographs in which:

FIG. 1 is a top perspective view of an open kit box showing its two half sections inside per the present invention;

FIG. 2 is a top perspective view of the kit box from FIG. 1 with its various contents laid out from left to right;

FIG. 3 is a top perspective view of the right side contents holder with its various compartments;

FIG. 4 is a top schematic view of the contents holder from FIG. 3 with schematic representations of the contents in the various compartments;

FIG. 5 is a top schematic view showing the positioning of one mold in its mold holder compartment adjacent a flower parts drying tray per one embodiment of this invention;

FIG. 6 is a top schematic view showing a user separating the two halves of the epoxy resin packet for mixing their contents together prior to disposing in a mold per this invention;

FIG. 7 is a side schematic view showing the mixed resin packet being poured into a mold;

FIG. 8 is a side partial sectional view of the mold from FIG. 7 showing a lower most level being filled with resin and a bubble popper used to remove bubbles in said resin;

FIG. 9 is a side partial sectional view of the mold and lower resin layer from FIG. 8 showing the placement of a dried flower part using tweezers supplied with the kit;

FIG. 10 is a side schematic view showing a user removing a fully finished product from its mold per one embodiment of this invention; and

FIG. 11 is a photograph showing a representative a ring holder made with this invention.

### DESCRIPTION OF PREFERRED EMBODIMENTS

In recent years, processed or preserved flowers have attracted attention. A preserved flower is a flower that has been replaced with water in the tissue for cut flowers such as roses and carnations. The goal is to keep the general texture, flower color, etc. as a keepsake. One known method for producing a preserved flower requires using polyethylene glycol as a preservation solution. However, that preserved flower severely deteriorates particularly under high temperature and/or high humidity conditions.

Therefore, the cut flowers to which the present invention is applied maintains their close to original form (i.e., shape, texture, flower color, etc.) indefinitely.

Cut flowers that have undergone a known dipping process may have an unnatural color or texture due to the preservation solution adhering to the surface. This invention avoids any such discoloration.

One Kit and Method of Use Embodiment

The present invention includes: (1) a selecting and cutting step; (2) a drying step; (3) a mold arranging step; and (4) a resin adding step with (5) an optional final product polishing step, if necessary.

(1) the selecting and cutting step

First, the flower arrangement is configured so as to selectively cut away appropriately sized flowers and greens that will be promptly dried, arranged in a mold and shortly thereafter, encased with resin for eternal preservation purposes.

(2) the drying step

Next, the cut flowers and greens are dehydrated in the drying step by immersing them for a predetermined time in a container to which is added a silica drying gel: beneath, adjacent and over said clippings.

(3) the mold arranging step

After sufficient drying, the clippings are arranged in a first product mold using tweezers. These tweezers may be used to hold the clippings in place, temporarily, while resin is fed thereabout.

(4) the resin adding step

From the dispenser of duly mixed resin, material is poured ABOUT the clippings held in the mold and allowed to set a proper time. A bubble popping stick/popper may be used for stirring or otherwise removing bubbles from the resin being added to the mold.

(5) product polishing step—optional

To remove the end product from the mold, simply pull it away from the cured end product for possible reuse in another floral preservation project. Thereafter, a polishing cloth may be used for putting a final luster on the fully preserved floral end product.

The present invention protects and permanently preserves a variety of flowers including small carnations, parts of roses, chrysanthemums, and the like. In addition, this invention may be used to eternalize the accessories/garnish flowers (like baby's breath) and/or ferns and other greens associated with such formal floral arrangements/bouquets. The present invention is not limited to these flowers alone, though.

### Example 1—Kit Contents

Silica (beaded or granular)

alternative: any/all other drying agents, such as activated clay or the like.

Resin (epoxy)

a custom blend, made in two parts, before manually mixing and adding to the mold, preferably sequentially (i.e., in layers).

alternative: other types of publicly made and sold resins/polymers ns.

Mold (silicone)

alternative: any type of mold material, such as rigid plastic, 3D printed, etc.

Gloves (disposable),

Tweezers (preferably bamboo); Bubble popper stick, small scissors (optional); polishing cloth (optional)

Instructions/directions card

Kit Content Packaging

The silica will be packaged in one divided unit in the master box/container. They are separated by a clip or “burstable” seam. Once the seam is broken/removed, the resin and hardener can be mixed together while still inside of the packaging. This act successfully activates the resin all while keeping your hands clean and mess free! Once thoroughly mixed, the resin is ready to be dispensed directly from packet into mold. See details in “Kit Main Method Steps” below.

By pulling the package halves away from one another the package contents are combined for subsequent mixing (by kneading) and eventual addition to the mold for making into an end product/flower preservative. After mixing, the contents are incrementally poured into the mold for creating a base layer for the cut and dried flower parts to rest on before additional mixed resin is added to the mold to fully fill the same. See, details in “Kit Method” below.

Kit Main Method Steps

### Step One: Flower Preservation

Within a given timeframe (ideally, within 72 hours after wedding day), an individual will begin the flower preservation process portion of the kit.
I. Remove and open the lid/top of your “preservation box.”
II. Remove the 2 bags of silica from the “preservation box.”
III. Open #1 bag of silica and empty the entire contents into the “preservation box. This will effectively create a “base layer” of silica gel for your flowers to rest on in the next step.
IV. Using scissors, cut and remove some of your favorite, small elements from your bouquet or boutonnière.
V. Lay these flower cuts onto the base layer of your silica.
VI. Once all flower cuts/elements are laid out, open #2 bag of silica and begin covering the florals until fully embedded in silica.
VI. Place the lid/top of your “preservation box” back on and let the box sit in a cool, dry space for at least about 12 days.

### Step Two: Artwork Creation

After 12 days of your flowers being embedded in silica, they will be fully “prepped” and ready to turn into your final artworks. It is now time to create your art!
I. Open your “preservation box” and carefully remove your flowers from the silica. This part is like a treasure hunt or tiny, sandbox dig.
II. Once all flowers are removed from the “preservation box” and set aside, you may safely discard your “preservation box” (with silica inside) in an environmentally conscious manner.
III. Open your “artwork creation” kit and position mold as instructed.
IV. Select resin packet #1, mix and dispense as instructed. This layer of resin will act as a base layer for flowers to stick/adhere to.
V. Immediately place desired flowers inside of mold and arrange to preference.
VI. Let sit for a minimum of 2 hours, though it can be longer.
VII. After 2 hours (or longer) has passed, repeat step IV with resin packet #2. This layer of resin will act as a solidifier to ensure flowers inside of the mold are secure and do not shift or float in the third and final layer of resin.
VIII. Let sit for a minimum of 2 hours, or longer.
IX. After 2 hours (or longer) has passed, repeat step IV with resin packet #3. This final layer will ensure your florals are 100% embedded and completes the casting process.
X. Let mold sit to cure the resin for at least 24 hours.
XI. Remove fully cured artwork from mold and enjoy!

### Artwork Options/Forms

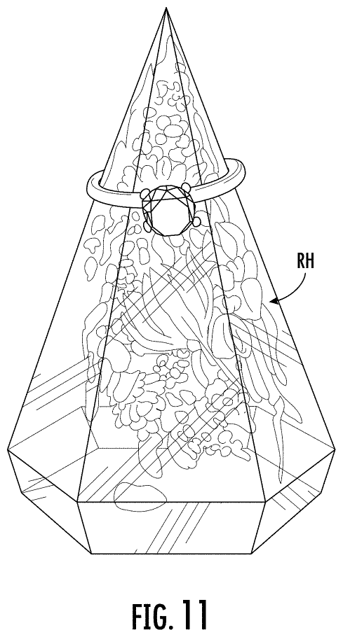

Our first Floral Preservation Kit will effectively turn the client/customer's wedding florals into one piece of ring holder artwork. Larger kits, or expansion packs, containing greater contents of resins and multiple molds, may be used to provide the client/customer a choice of end products to make: 1 ring holder+1 paperweight, 2 ring holders OR 2 paper weights. At online checkout, the clients/customers will be able to choose their combo. This way, each partner gets to have an artwork made with his/her wedding bouquet and/or boutonniere. Please see accompanying photo at FIG. 11 for a representative paperweight and a representative ring holder.

In the future, we will be creating a variety of “add-on” artwork creation kits. For example, in addition to the primary kit purchased, a customer could select an add-on creation kit for turning parts of their bouquet into different and unique forms, like jewelry, coasters, candle holders, Christmas ornaments, etc.

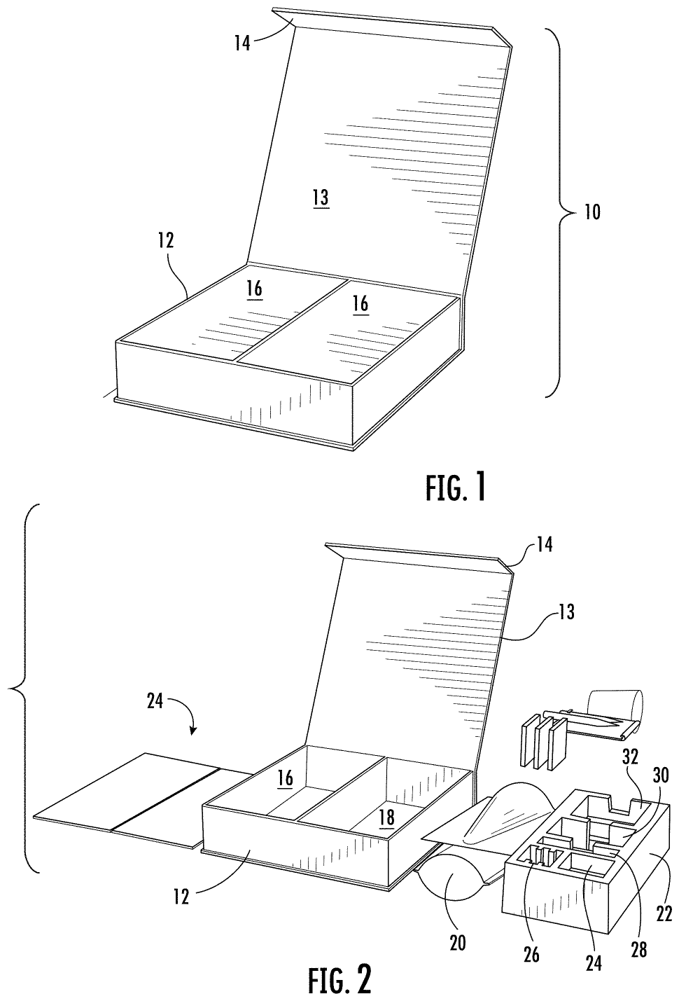

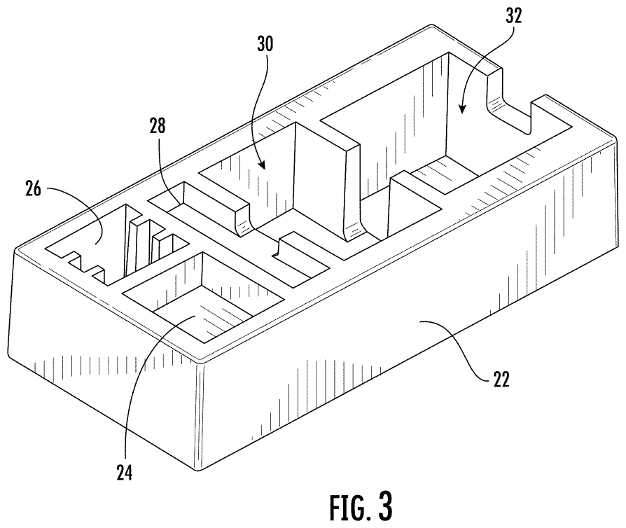

Referring now, more specifically, to the accompanying drawings and photographs, there is shown in FIGS. 1 and 2, an outermost kit box (generally 10) having a main body compartment 12, a folding lid 13 and sealing flap 14. Fitting securely inside main body component 12 are two half boxes 16 and 18. The left box 16 contains multiple resin packets (item 20 in FIG. 2) while the right box 18 contains a thermoformed tray 22 with its various other kit components stored in respective compartments described below. A rigid cover 24 fits over both halves and contains pockets for instructions on use.

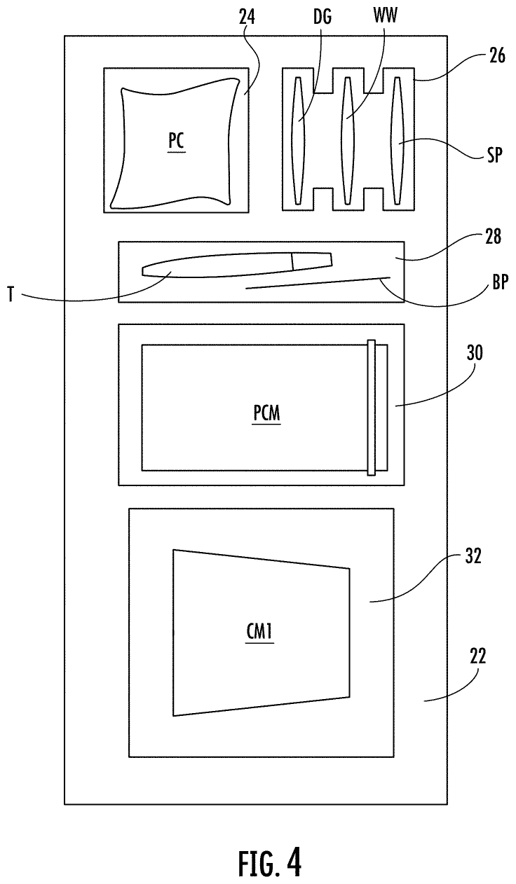

The thermoformed tray 22 consists of five recessed compartments as seen in FIGS. 2 through 4. A first compartment 24 holds a polishing cloth PC. To the right of first compartment 24, there is initially stored in subdivided compartment 26 packets containing disposable gloves DG, wet wipes WW and a sanding pad SP. Beneath compartments 24, 26, thermoformed tray 22 includes a recess compartment 28 for holding tools like tweezers T and a bubble popper BP.

In the two largest recesses in thermoformed tray 22, there is a compartment 30 for holding a packet of casting medium PCM directly above a large, hollow compartment 32 in which at least one casting mold CM1 is shipped for use. The latter may also be used to hold (hands free) the very casting mold during mold filling, curing and end product assembly.

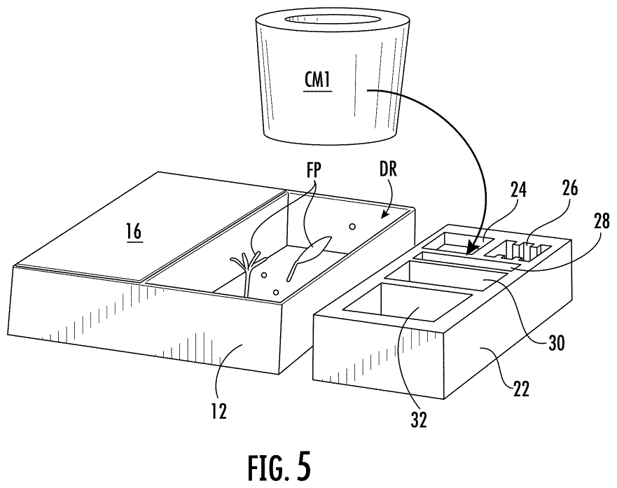

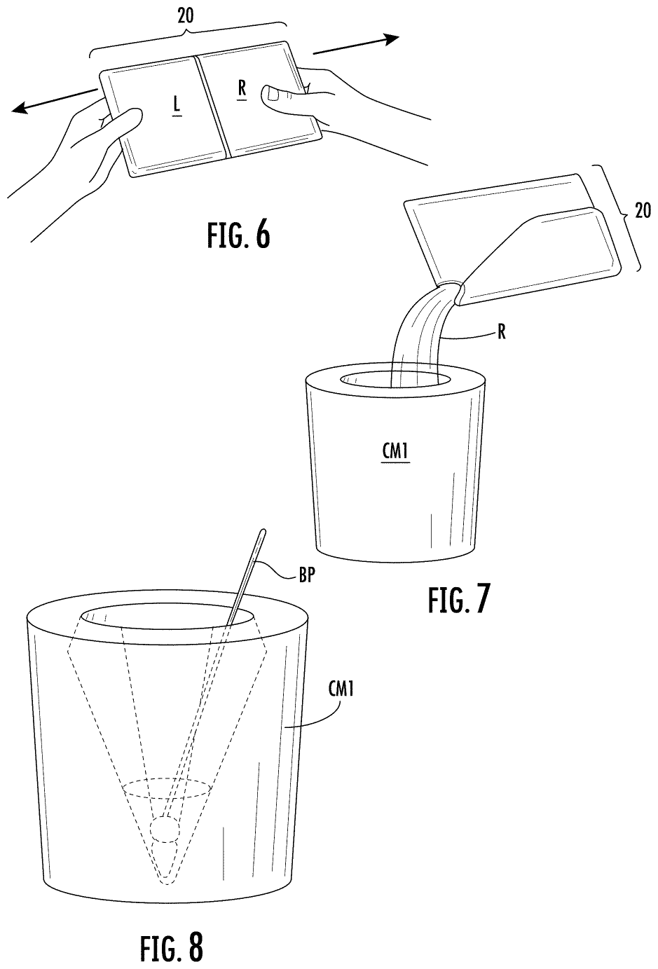

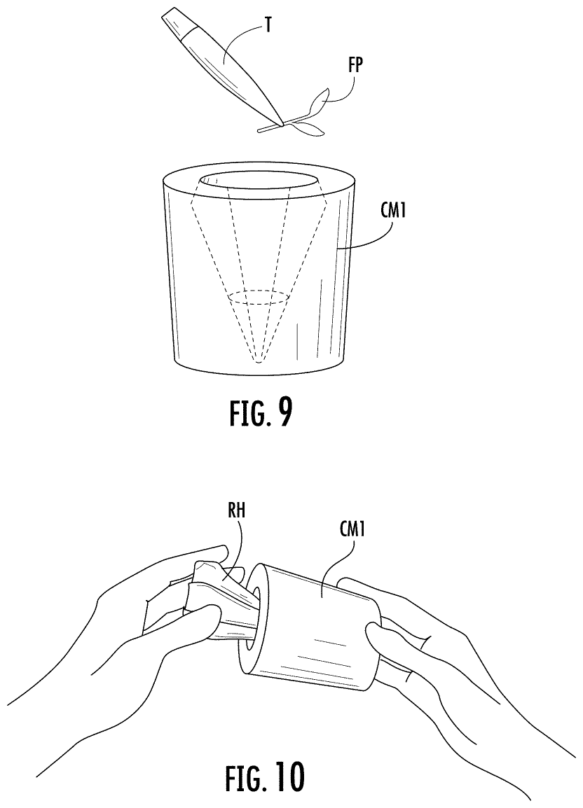

FIGS. 5 through 10 sequentially show use of the aforementioned kit contents to dry flower parts FP in a drying recess DR filled with sand or another drying agent (FIG. 5). In one embodiment, drying recess DR is exposed by the removal of thermoformed tray 22 from right box 18. FIG. 6 then shows the pulling apart of a representative resin packet 20, in two halves L and R, to mix together its contents. After mixing, the resin contents R of packet 20 may be poured into the base, i.e., the lower most section of ring holder casting mold CM1 per FIG. 7. A bubble popper BP can be used to manually work out any undesired bubbles that may have formed from initial resin pouring. That sub-step is depicted in accompanying FIG. 8. Thereafter, kit tweezers T are used to hold a piece of dried flower part FP for preferred user positioning in casting mold CM1 before additional resin is added over the first flower part FP and the process repeated. See, FIG. 9. When casting mold CM1 is fully filled with resin 20 and duly positioned flower parts FP, the mold is allowed to rest (preferably in a recess in thermoformed tray 22 for at least about 2 hours to catalyze/harden). Once fully set in resin, the finished flower part, in this case a ring holder RH can be removed from its mold CM1 as best seen in FIG. 10.

FIG. 11 is a photograph showing an actual finished end part, or Ring Holder RH made with the aforementioned kit.

Having described the best modes currently known for practicing this system and method, it is to be understood that the scope of this invention may be further described by the attached claims.

### SEQUENCE LISTING

Not applicable

What is claimed is:

1. A kit for preserving live flowers cut from a sentimental bouquet or other flower arrangement, said kit comprising, in one box:
(a) a pre-packaged amount of silica (or other drying) gel;
(b) one or more packets of pre-measured epoxy resin;
(c) tools including a mixing stick and mixing cup;
(d) one or more end product molds, and
(e) a directions/instruction card.

2. The kit from claim 1 wherein the packets of epoxy resin are separated for shipping but pulled apart for mixing together prior to end product mold filling,

3. The kit from claim 1, which further includes gloves, wet wipes and a sanding pad.

4. The kit from claim 1, which further includes a polishing cloth.

5. The kit from claim 1 wherein the end product molds are selected from the group consisting of a ring holder and a paperweight.

6. The kit from claim 1 wherein the end product molds are reusable.

7. The kit from claim 1 wherein the end product molds may be used to make jewelry, coasters, candle holders or Christmas ornaments.

8. The kit from claim 1, which will allow customers an option to upgrade and order supplemental end product molds.

9. The kit from claim 1 wherein the customers may order additional packets of silica gel, epoxy resin or both.

10. The kit from claim 1, which ships in one box having a tray portion with multiple compartments at least one of which is suitable for holding the end product mold during filling and curing.

11. A method for preserving live flowers cut from a sentimental bouquet or other flower arrangement, said method comprising the steps of:
(a) providing a kit that contains:
(i) a pre-packaged amount of silica (or other drying) gel;
(ii) one or more packets of pre-measured epoxy resin;
(iii) mixing tools;
(iv) one or more end product molds, and
(v) a directions/instruction card;
(b) providing a bouquet or other arrangement of fresh flowers;
(c) selecting and cutting a plurality of flowers and greens from the bouquet;
(d) placing the cuttings into a container with drying gel;
(e) arranging the dried cuttings in one of the end product molds from the kit;
(f) mixing the resin;
(g) periodically adding mixed resin about the arranged dry cuttings, in layers, from mold bottom to mold top until the mold is filled with arranged dry cuttings and mixed resin; and
(h) allowing the filled mold to fully cure.

12. The method of claim 11, which further includes:
(i) removing the end product from the mold and polishing as needed.

13. The method of claim 11, which further includes:
reusing the mold to make a second end product.

14. The method of claim 11 wherein the end product mold is for making a dried flower containing ring holder.

15. The method of claim 11 wherein the end product mold is used to make jewelry, a paperweight, a coaster, a candle holder or a Christmas ornament.
